(19) United States
(12) Patent Application Publication
(10) Pub. No.: US 2024/0182734 A1
(43) Pub. Date: Jun. 6, 2024

(54) Ink Jet Ink Composition And Recording Method

(71) Applicant: SEIKO EPSON CORPORATION, Tokyo (JP)

(72) Inventors: Ryota IMAI, Shiojiri (JP); Kazuki SHIMURA, Matsumoto (JP)

(21) Appl. No.: 18/512,222

(22) Filed: Nov. 17, 2023

(30) Foreign Application Priority Data
Nov. 18, 2022 (JP) 2022-184616

(51) Int. Cl. C09D 11/328; B41J 2/005; C09B 1/16; C09B 67/20; C09D 11/033; C09D 11/037; C09D 11/38; D06P 1/62; D06P 1/92; D06P 5/28; D06P 5/30

(52) U.S. Cl. CPC C09D 11/328; B41J 2/0057; C09B 1/16; C09B 67/0066; C09D 11/033; C09D 11/037; C09D 11/38; D06P 1/625; D06P 1/928; D06P 5/006; D06P 5/30; B41J 2002/012

(57) ABSTRACT

An ink jet ink composition includes: a colorant including a compound (A) represented by formula (1) below; an anionic dispersant; water; a surfactant; and a water-soluble organic solvent. In high-performance liquid chromatography (HPLC) analysis of the colorant at a measurement wavelength of 500 nm, the peak area of a compound (B) represented by formula (2) is 1.4% or less based on 100% of the total peak area of the colorant, and the peak area of a compound (C) represented by formula (3) is 0.8% or less based on 100% of the total peak area of the colorant. The water-soluble organic solvent includes a glycerol and a glycol.

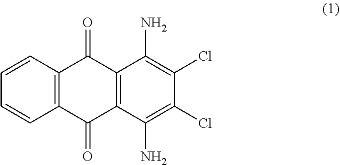

The present application is based on, and claims priority from JP Application Serial Number 2022-184616, filed Nov. 18, 2022, the disclosure of which is hereby incorporated by reference herein in its entirety.

### BACKGROUND

### 1. Technical Field

The present disclosure relates to an ink jet ink composition and a recording method.

### 2. Related Art

An ink jet recording method is capable of recording high-resolution images with a relatively simple apparatus, and is rapidly developing in various fields. In particular, various studies have been made on an ink jet recording method using a dye.

For example, JP-A-2003-238848 describes an ink for ink jet printing, containing 1, 4-diamino-2,3-dichloroanthraquinone (C.I. Disperse Violet 28) as a dye.

However, the use of 1,4-diamino-2,3-dichloroanthraquinone (C.I. Disperse Violet 28) as a dye in an ink has the problems of poor color saturation of a dyed product and poor storage stability of the ink.

### SUMMARY

According to an aspect of the present disclosure, an ink jet ink composition includes: a colorant including a compound (A) represented by formula (1) below; an anionic dispersant; water; a surfactant; and a water-soluble organic solvent, in which in high-performance liquid chromatography (HPLC) analysis of the colorant at a measurement wavelength of 500 nm, a peak area of a compound (B) represented by formula (2) below is 1.4% or less based on 100% of a total peak area of the colorant, and a peak area of a compound (C) represented by formula (3) below is 0.8% or less based on 100% of the total peak area of the colorant, and in which the water-soluble organic solvent includes a glycerol and a glycol:

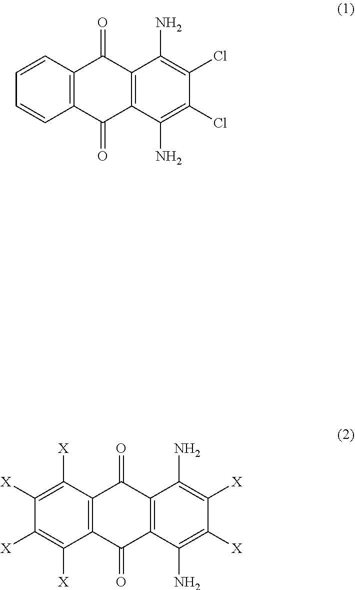

where X represents a hydrogen atom or a chlorine atom, X's are same or different, and the formula (2) excludes a structure of the formula (1),

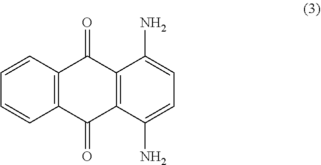

According to another aspect of the present disclosure, a recording method includes an ejection step of ejecting the above-described ink jet ink composition by an ink jet method so as to apply the above-described ink jet ink composition to an intermediate transfer medium; and a transfer step of transferring the ink jet ink composition applied to the intermediate transfer medium to a recording medium.

### DESCRIPTION OF EMBODIMENTS

Embodiments of the present disclosure will now be described. The embodiments described below illustrate examples of the present disclosure. The present disclosure is in no way limited to the below-described embodiments. Various modifications and changes may be made to the embodiments without departing from the spirit and scope of the present disclosure. It is to be noted that not all the features described below are essential to the present disclosure.

### 1. INK JET INK COMPOSITION

An ink jet ink composition according to an embodiment of the present disclosure (hereinafter also referred to simply as “the ink composition” or “the ink”) includes a colorant including a compound (A) represented by formula (1) below, an anionic dispersant, water, a surfactant, and a water-soluble organic solvent. In high-performance liquid chromatography (HPLC) analysis of the colorant at a measurement wavelength of 500 nm, the peak area of a compound (B) represented by formula (2) below is 1.4% or less based on 100% of the total peak area of the colorant, and the peak area of a compound (C) represented by formula (3) below is 0.8% or less based on 100% of the total peak area of the colorant. The water-soluble organic solvent includes a glycerol and a glycol.

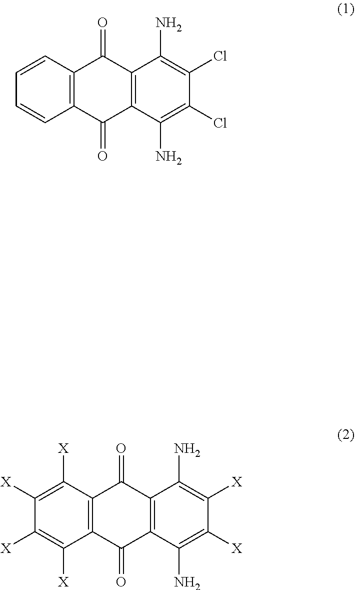

where X represents a hydrogen atom or a chlorine atom, X's may be the same or different, and formula (2) excludes the structure of formula (1),

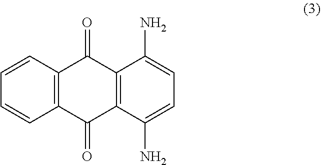

The use of a colorant including 1,4-diamino-2,3-dichloroanthraquinone (C.I. Disperse Violet 28) which is the compound (A) represented by the formula (1) in an ink has the problems of poor color saturation of a dyed product and poor storage stability of the ink.

The present inventors, through their intensive studies, have now found that the compound (B) represented by the formula (2) causes a reduction in the color saturation of a dyed product and a reduction in the storage stability of the ink, and that the compound (C) represented by the formula (3), in particular, causes a reduction in the storage stability of the ink.

Thus, according to the ink jet ink composition of this embodiment, excellent color saturation of a dyed product and excellent storage stability of the ink can be achieved by making the peak area of the compound (B) and the peak area of the compound (C) each not more than a particular value in HPLC analysis of the colorant including the compound (A).

The respective components of the ink jet ink composition of this embodiment will be described.

### 1.1 Colorant

### 1.1.1 Compound (A)

The ink jet ink composition of this embodiment contains a colorant including a compound (A) represented by formula (1) below.

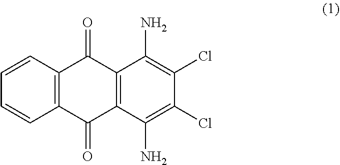

The compound (A) represented by the formula (1) is

1,4-diamino-2,3-dichloroanthraquinone and is referred to by the color index name “C. I. Disperse Violet 28”.

When the colorant including the compound (A) represented by the formula (1) is analyzed by high-performance liquid chromatography (HPLC) at a measurement wavelength of 500 nm, the peak area of the compound (A) is preferably 98.6% or more, more preferably 98.8% or more, even more preferably 99.0% or more, and particularly preferably 99.4% or more based on 100% of the total peak area of the colorant. In such a case, the color saturation of a dyed product and the storage stability and ejection stability of the ink are likely to be further enhanced.

As used herein, the high-performance liquid chromatography (HPLC) analysis refers to a method of analysis in which “a liquid mobile phase is pressurized by a pump or the like and passed through a column, and analyte species are separated and detected with high performance by utilizing differences in interaction (adsorption, distribution, ion exchange, size exclusion, etc.) with a stationary phase and the mobile phase” (JIS K 0124:2011 General rules for high performance liquid chromatography). Although there is no particular limitation on analysis conditions, etc. in the HPLC analysis as long as at least the compounds (A) to (C) can be detected simultaneously, it is preferred to perform the analysis at a measurement wavelength of 500 nm. Thus, it is preferred to use a method which involves irradiating the compounds (A) to (C), which have been separated by a column, with light having a wavelength of 500 nm in an absorptiometer, and measuring the amount of light absorbed by each compound. This method can quantitatively detect the compounds (A) to (C) more accurately, which is likely to further enhance the color saturation of a dyed product and the storage stability and ejection stability of the ink. More preferably, for example, the following analysis conditions can be employed.

### Example of HPLC Analysis Conditions

Apparatus used: SPD-M20A (manufactured by Shimadzu Corporation)
Column: Inertsil ODS-2 (4.6 mm×250 mm) (particle size 5 μm) Column temperature: 40° C.
Eluent: acetonitrile/5 mM ammonium acetate=70/30
Flow rate: 0.8 mL/min
Sample injection volume: 2 μL
Detection wavelength: 500 nm

A peak area refers to an area surrounded by a baseline and a peak line in a chromatogram. In particular, a peak area may be an integrated value of the difference between a peak signal value and a baseline signal value, as calculated over the range from the beginning to the end of a peak, or may be a value obtained by multiplying a peak width (half width) at the midpoint of a peak height by the peak height.

### 1.1.2 Compound (B)

In high-performance liquid chromatography (HPLC) analysis at a measurement wavelength of 500 nm of the colorant contained in the ink jet ink composition of this embodiment, the peak area of a compound (B) represented by formula (2) below is 1.4% or less, preferably 1.2% or less, more preferably 1.0% or less, even more preferably 0.8% or less, particularly preferably 0.6% or less, and more particularly preferably 0.38 or less based on 100% of the total peak area of the colorant. Excellent color saturation of a dyed product can be achieved when such peak area is 1.4% or less based on 100% of the total peak area of the colorant. When such peak area is within the above preferable ranges, superior color saturation of a dyed product can likely be achieved.

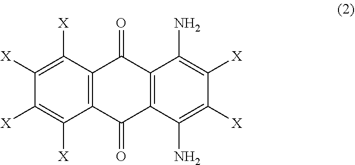

where X represents a hydrogen atom or a chlorine atom, X's may be the same or different, and formula (2) excludes the structure of formula (1).

### 1.1.3 Compound (C)

In high-performance liquid chromatography (HPLC) analysis at a measurement wavelength of 500 nm of the colorant contained in the ink jet ink composition of this embodiment, the peak area of a compound (C) represented by formula (3) below is 0.8% or less, preferably 0.6% or less, more preferably 0.4% or less, even more preferably 0.2% or less, particularly preferably 0.1% or less, and more particularly preferably 0.05% or less based on 100% of the total peak area of the colorant. Excellent storage stability of the ink can be achieved when such peak area is 0.8% or less based on 100% of the total peak area of the colorant. When such peak area is within the above preferable ranges, superior storage stability of the ink can likely be achieved.

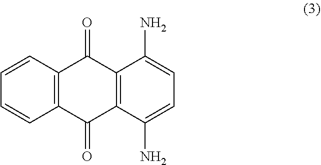

### 1.1.4 Other Compounds

The colorant contained in the ink jet ink composition of this embodiment may include a compound (s) other than the compounds (A) to (C) as long as the effects of the present disclosure are not impaired. Examples of such compounds include C.I. Disperse Blue 359, C.I. Disperse Blue 60, C.I. Disperse Blue 360, C.I. Disperse Orange 25, C.I. Solvent Orange 60, C.I. Disperse Yellow 54, C.I. Disperse Yellow 82, C.I. Disperse Red 60, and C.I. Disperse Red 364.

### 1.1.5 Purification Method

There is no particular limitation on a method for making the peak area of the compound (B), represented by the formula (2), and the peak area of the compound (C), represented by the formula (3), each not more than the above-described particular value in HPLC analysis of the colorant including the compound (A) represented by the formula (1). For example, a method may be used which involves purifying a composition (colorant) including the compound (A), the compound (B) and the compound (C) by a known purification method.

There is no particular limitation on the purification method, and it is possible to use a common method, for example, extraction such as solid-liquid extraction, liquid-liquid extraction, reflux extraction, or Soxhlet extraction; immersion; or stirring. These methods may be used alone or in combination of two or more. For example, solid-liquid extraction and liquid-liquid extraction may be used in combination. When two or more methods are combined, the order of the methods can be set arbitrarily according to the purpose such as extraction efficiency.

When solid-liquid extraction is carried out, an organic solvent, for example, can be used as an extraction solvent. The organic solvent may be a hydrophilic organic solvent or a hydrophobic organic solvent. Examples of the extraction solvent include monohydric, dihydric, or polyhydric alcohols and aqueous solutions thereof; ketones such as acetone and methyl ethyl ketone; esters such as methyl acetate and ethyl acetate; linear ethers such as diethyl ether; saturated or unsaturated hydrocarbons such as pentane and hexane; aromatic hydrocarbons such as benzene and toluene; halogenated hydrocarbons such as dichloromethane, chloroform, dichloroethane, and carbon tetrachloride; carbon dioxide and supercritical carbon dioxide; edible oils such as rapeseed oil and soybean oil; and oils and fats such as diacylglycerol (DAG), medium-chain fatty acid oils, squalane, and squalene. These extraction solvents may be used alone or in combination of two or more. Among these extraction solvents, methanol, ethanol, and isopropyl alcohol are preferred.

There is no particular limitation on solid-liquid extraction conditions as long as the conditions allow sufficient extraction. For example, the amount of the extraction solvent used is preferably 1 to 100 mL per gram of the composition. The extraction time is generally long when the temperature of the solvent is low; the extraction time may be shorter when the solvent is at a higher temperature. An extraction operation may be performed twice or more. In an example of preferable extraction conditions, two extraction operations, each at 10 to 50° C. for 1 to 2 hours, may be performed.

There is no particular limitation on a method for separating a solid in the solid-liquid extraction. For example, a solid can be separated and recovered by filtration using a Buchner funnel and filter paper. Upon the filtration, an extraction solvent may be added onto a cake in the Buchner funnel. This can increase the purification effect.

The extraction solvent generally remains in the cake after the extraction operation; therefore, an additional operation to remove the solvent may be performed. Examples of the solvent removal operation include an operation which involves removing the solvent under reduced pressure; an operation which involves suspending the cake in water, followed by filtration; and an operation which involves adding water onto the cake, followed by filtration.

The content of the colorant is preferably not less than 0.1% by mass and not more than 15% by mass, more preferably not less than 0.5% by mass and not more than 10% by mass, even more preferably not less than 1.0% by mass and not more than 8.0% by mass, and particularly preferably not less than 1.5% by mass and not more than 5.0% by mass based on the total mass of the ink jet ink composition. When the content of the colorant is within the above ranges, the color saturation of a dyed product and the storage stability and ejection stability of the ink can likely be made well-balanced.

### 1.2 Anionic Dispersant

The ink jet ink composition of this embodiment contains an anionic dispersant. The anionic dispersant can disperse the colorant well in a liquid medium. There is no particular limitation on the anionic dispersant as long as it is to be ionized into an anion. An aromatic sulfonic acid condensate, such as a naphthalenesulfonic acid condensate or a benzenesulfonic acid condensate, is an example of the anionic dispersant. The aromatic sulfonic acid condensate may be in the form of a sulfonic acid salt. Examples of the salt include an alkali metal salt such as a sodium salt, a lithium salt or a potassium salt, and an ammonium salt.

Examples of the naphthalenesulfonic acid condensate include a formalin condensate of an alkylnaphthalenesulfonic acid such as (α, β-) naphthalenesulfonic acid, methylnaphthalenesulfonic acid or butylnaphthalenesulfonic acid; a formalin condensate of β-naphtholsulfonic acid; a formalin condensate of 2-naphthol-6-sulfonic acid; and a salt thereof.

Examples of the benzenesulfonic acid condensate include a formalin condensate of cresolsulfonic acid, a formalin condensate of phenolsulfonic acid, a formalin condensate of ligninsulfonic acid, and a salt thereof.

Such anionic dispersants may be used alone or in combination of two or more.

Among them, a naphthalenesulfonic acid condensate is preferred, and a formalin condensate of sodium naphthalenesulfonate is more preferred as the anionic dispersant. Such a condensate has a high solubility in water and can disperse the colorant well, and therefore is likely to further inhibit the formation of foreign matter and further enhance the storage stability and ejection stability of the ink. The formalin condensate of sodium naphthalenesulfonate is more preferably a formalin condensate of sodium β-naphthalenesulfonate.

The content of the anionic dispersant is preferably not less than 0.1% by mass and not more than 15% by mass, more preferably not less than 0.5% by mass and not more than 10% by mass, even more preferably not less than 1.0% by mass and not more than 8.0% by mass, and particularly preferably not less than 1.5% by mass and not more than 5.0% by mass based on the total mass of the ink composition.

Further, the content of the anionic dispersant is preferably 10 to 300 parts by mass, more preferably 30 to 200 parts by mass, and even more preferably 50 to 150 parts by mass based on 100 parts by mass of the solid content of the colorant.

In addition to the anionic dispersant, a nonionic dispersant or a polymer dispersant, for example, may be used as long as it does not impair the effects of the present disclosure.

### 1.3 Water

The ink jet ink composition of this embodiment contains water. The water may be one having a reduced content of ionic impurities, for example, pure water such as ion exchange water, ultrafiltrated water, reverse osmosis water, or distilled water, or ultrapure water. Further, it is possible to use water which has been sterilized, for example, by ultraviolet irradiation or by the addition of hydrogen peroxide. The use of such water can inhibit the growth of bacteria or fungi when the ink jet ink composition is stored over a long period of time.

The content of water is preferably 20 to 80% by mass, more preferably 30 to 70% by mass based on the total mass of the ink composition.

### 1.4 Surfactant

The ink jet ink composition of this embodiment contains a surfactant. Examples of the surfactant include a silicone surfactant, an acetylene glycol surfactant, and a fluorochemical surfactant.

### 1.4.1 Silicone Surfactant

The surfactant is preferably a silicone surfactant. A silicone surfactant is likely to be excellent in the function of reducing the surface tension of the ink. Further, the ink is likely to exhibit excellent surface tension stability, i.e., undergo little change in the surface tension even during a long period of storage. This may further enhance the storage stability and ejection stability of the ink.

There is no particular limitation on the silicone surfactant as long as it is a surfactant having a polyorganosiloxane structure. Examples of the silicone surfactant include an unmodified polyorganosiloxane, an ether-modified polyorganosiloxane, an ester-modified polyorganosiloxane, an epoxy-modified polyorganosiloxane, an amine-modified polyorganosiloxane, a carboxy-modified polyorganosiloxane, a fluorine-modified polyorganosiloxane, an alkyloxy-modified polyorganosiloxane, a mercapto-modified polyorganosiloxane, a (meth) acryl-modified polyorganosiloxane, a phenol-modified polyorganosiloxane, a phenyl-modified polyorganosiloxane, a carbinol-modified polyorganosiloxane, and an aralkyl-modified polyorganosiloxane. Among them, an unmodified polyorganosiloxane, an ether-modified polyorganosiloxane, and an ester-modified polyorganosiloxane are preferred, and a polyether-modified dimethylsiloxane is more preferred.

As used herein, “ (meth) acryl” refers to acryl or methacryl.

There is no particular limitation on commercial products of the silicone surfactant. Examples include BYK-306, BYK-307, BYK-333, BYK-337, BYK-341, BYK-345, BYK-346, BYK-347, BYK-348, BYK-349, and BYK-378 (trade names, available from BYK Japan KK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.).

### 1.4.2 Other Surfactants

There is no particular limitation on the acetylene glycol surfactant. Examples include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all trade names, available from Air Products Japan); Olfin B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (all trade names, manufactured by Nissin Chemical Industry Co., Ltd.); and Acetylenol E00, E00P, E40, and E100 (all trade names, manufactured by Kawaken Fine Chemicals Co., Ltd.).

A fluorine-modified polymer is preferably used as the fluorochemical surfactant. BYK-340 (trade name, available from BYK Japan KK) is an example of a commercially available product.

A single surfactant or a combination of two or more surfactants may be used.

The content of a surfactant is preferably 0.050 to

5.0% by mass, more preferably 0.10 to 3.0% by mass, and even more preferably 0.10 to 1.5% by mass based on 100% by mass of the ink composition.

### 1.5 Water-soluble Organic Solvent

The ink jet ink composition of this embodiment contains a water-soluble organic solvent. The “water-soluble organic solvent” may be any organic solvent that exhibits solubility in water. For example, an organic solvent having a solubility in water at 20° C. of 10 g/100 g water or more can be preferably used.

Examples of the water-soluble organic solvent include a glycerol, a glycol, a glycol ether, an ester, a cyclic ester, a nitrogen-containing solvent, and a monoalcohol. The nitrogen-containing solvent may be a cyclic or non-cyclic amide. The non-cyclic amide may be an alkoxyalkyl amide.

### 1.5.1 Glycerol

The water-soluble organic solvent includes a glycerol. The glycerol has an alkane or polyether structure as a skeleton, and has three hydroxy groups in the molecule. Examples of the glycerol include glycerin, trimethylolethane, trimethylolpropane, 1,2,5-hexanetriol, and 1,2,6-hexanetriol.

The glycerol is preferably a glycerol having 3 to 5 carbon atoms, more preferably glycerin from the viewpoint of being likely to achieve superior ejection stability of the ink.

The content of the glycerol is preferably 3 to 30% by mass, more preferably 5 to 25% by mass, even more preferably 7 to 23% by mass, and particularly preferably 10 to 20% by mass based on the total mass of the ink composition.

### 1.5.2 Glycol

The water-soluble organic solvent includes a glycol. The glycol has two hydroxy groups in the molecule and includes, for example, an alkanediol and a condensate produced through intermolecular condensation of hydroxy groups between two or more molecules of an alkanediol.

The alkanediol is, for example, a compound in which two hydrogen atoms of an alkane are substituted with two hydroxy groups. Examples of the alkanediol include 1,2-alkanediols such as ethylene glycol (also termed ethane-1,2-diol), propylene glycol (also termed propane-1,2-diol), 1,2-butanediol, 1,2-pentanediol, 1,2-hexanediol and 1,2-octanediol; 1,3-propanediol, 1,3-butyleneglycol (also termed 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2, 4-diol, 1,6-hexanediol, 2-ethyl-2-methyl-1,3-propanediol, and 2-methyl-2-propyl-1,3-propanediol.

The condensate produced through intermolecular condensation of hydroxy groups between two or more molecules of an alkanediol is, for example, a dialkylene glycol such as diethylene glycol or dipropylene glycol, or a trialkylene glycols such as triethylene glycol or tripropylene glycol.

The glycol is preferably a 1,2-alkanediol, more preferably a 1,2-alkanediol having 2 to 5 carbon atoms, and even more preferably propylene glycol from the viewpoint of being likely to achieve superior ejection stability of the ink.

The content of the glycol is preferably 1 to 20% by mass, more preferably 3 to 18% by mass, even more preferably 5 to 15% by mass, and particularly preferably 7 to 13% by mass based on the total mass of the ink composition.

The content ratio between the glycerol and the glycol (glycerol: glycol) in the water-soluble organic solvent is preferably 3:2 to 20:3, more preferably 3:2 to 4:1, and even more preferably 3:2 to 11:3 based on mass. When the content ratio is within the above ranges, the ejection stability of the ink is likely to be superior.

### 1.5.3 Glycol Ether

The water-soluble organic solvent preferably further includes a glycol ether. The glycol ether is a compound in which one or more hydroxy groups of a glycol have been etherified. An alkylene glycol monoether or diether is preferred as the glycol ether. The etherified ether is preferably an alkyl ether. The alkylene of the alkylene glycol and the alkyl of the alkyl ether, constituting the glycol ether, preferably independently have 1 to 5 carbon atoms, more preferably 2 to 4 carbon atoms.

Examples of an alkylene glycol monoalkyl ether, for use as the glycol ether, include ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether.

Examples of an alkylene glycol dialkyl ether, for use as the glycol ether, include ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

The glycol ether preferably is an alkylene glycol monoalkyl ether, more preferably includes at least one of triethylene glycol monomethyl ether and triethylene glycol monoethyl ether from the viewpoint of being likely to achieve superior ejection stability of the ink.

In the ink jet ink composition of this embodiment, the water-soluble organic solvent preferably further includes the above-described glycol ether, and the content of the glycol ether is preferably not less than 1% by mass and not more than 3% by mass, more preferably not less than 2% by mass and not more than 3% by mass based on the total mass of the ink composition. When the content of the glycol ether is within the above ranges, the ejection stability of the ink is likely to be superior.

### 1.5.4 Other Water-Soluble Organic Solvents

The water-soluble organic solvent may also include an ester, a cyclic ester, an alkoxyalkyl amide, a cyclic amide, a monoalcohol, or the like.

### Ester

Examples of the ester include a glycol monoacetate such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, or methoxybutyl acetate; and a glycol diester such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, or dipropylene glycol acetate propionate.

### Cyclic Ester

Examples of the cyclic ester include a lactone such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε- octanolactone, δ-nonalactone, ε-nonalactone, or ε-decanolactone, and a compound in which a hydrogen atom (s) of a methylene group adjacent to a carbonyl group is substituted with an alkyl group having 1 to 4 carbon atoms.

### Alkoxyalkyl Amide

Examples of the alkoxyalkyl amide include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N, N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

### Cyclic Amide

The cyclic amide may be a lactam including a pyrrolidone such as 2-pyrrolidone, 1-methyl-2-pyrrolidone, 1-ethyl-2-pyrrolidone, 1-propyl-2-pyrrolidone, or 1-butyl-2-pyrrolidone.

### Monoalcohol

The monoalcohol may be, for example, a compound in which one hydrogen atom of an alkane is substituted with a hydroxy group. The alkane preferably has 10 or less carbon atoms, more preferably 6 or less carbon atoms, and even more preferably 3 or less carbon atoms. The alkane has 1 or more carbon atoms, preferably 2 or more carbon atoms. The alkane may be linear or branched. Examples of the monoalcohol include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxyethanol, benzyl alcohol, and phenoxypropanol.

The above-described various water-soluble organic solvents may be used alone or in combination of two or more.

The content of the water-soluble organic solvent is preferably not less than 10% by mass and not more than 50% by mass, more preferably not less than 15% by mass and not more than 40% by mass, and even more preferably not less than 20% by mass and not more than 30% by mass based on the total mass of the ink composition. When the content of the water-soluble organic solvent is within the above ranges, the ejection stability of the ink is likely to be superior.

In particular, the water-soluble organic solvent preferably further includes the above-described glycol ether, and the content of the water-soluble organic solvent is preferably not less than 15% by mass and not more than 40% by mass, more preferably not less than 20% by mass and not more than 35% by mass, and even more preferably not less than 25% by mass and not more than 32% by mass based on the total mass of the ink composition. In such a case, the ejection stability of the ink is likely to be superior.

### 1.6 Other Components

The ink jet ink composition of this embodiment may contain various additives such as a dissolution aid, a viscosity modifier, a pH adjuster, an antioxidant, a preservative, an anti-mold agent, a corrosion inhibitor, and a chelating agent for capturing metal ions that affect dispersion of the ink composition.

Such additives may be used alone or in combination of two or more.

There is no particular limitation on the content of each additive. The content may be not less than 0.01% by mass and not more than 5.0% by mass based on the total amount of the ink jet ink composition.

### 1.7 Ink Composition Production Method and Properties

The ink jet ink composition of this embodiment is obtained by mixing the components described above in an arbitrary order, and optionally subjecting the mixture to filtration or the like as necessary to remove impurities. The mixing of the components is preferably performed by a method in which materials are sequentially added to a container equipped with a stirring device such as a mechanical stirrer or a magnetic stirrer, and the materials are stirred and mixed in the container. The optional filtration may be performed e.g. by centrifugal filtration or filter filtration.

The ink jet ink composition of this embodiment preferably has a surface tension (static surface tension) at 20° C. of not less than 18 mN/m and not more than 40 mN/m, more preferably not less than 20 mN/m and not more than 35 mN/m, and even more preferably not less than 22 mN/m and not more than 33 mN/m from the viewpoint of a balance between image quality and reliability as an ink for ink jet recording. The measurement of surface tension can be carried out, for example, by using an automatic surface tensiometer CBVP-Z (trade name, manufactured by Kyowa Interface Science Co., Ltd.), and determining the surface tension of a platinum plate, which is wet with an ink, in an environment at 20° C.

From the same viewpoint, the viscosity of the ink at 20° C. is preferably not less than 3 mPa·s and not more than 10 mPa·s, more preferably not less than 3 mPa·s and not more than 8 mPa·s. The measurement of viscosity can be carried out in an environment at 20°C. using, for example, a viscoelasticity tester MCR-300 (trade name, manufactured by Anton Paar).

### 1.8 Application

The ink jet ink composition of this embodiment is suitable for use in a dyeing method (sublimation transfer method) for a fabric or the like utilizing sublimation transfer, e.g. a method which involves printing a sheet-like intermediate transfer medium such as paper by an ink jet method using an ink jet recording apparatus, superimposing the printed intermediate transfer medium on a recording medium such as a fabric, and then heating the laminate to sublimate and transfer the ink onto the recording medium.

### 2. RECORDING METHOD

A recording method according to an embodiment of the present disclosure includes an ejection step of ejecting the above-described ink jet ink composition by an ink jet method so as to apply the above-described ink jet ink composition to an intermediate transfer medium; and a transfer step of transferring the ink jet ink composition applied to the intermediate transfer medium to a recording medium.

According to the recording method of this embodiment, a dyed product having excellent color saturation can be obtained by the use of the ink jet ink composition described above. Further, since the ink is excellent in storage stability, the ink enables recording with excellent ejection stability.

The respective steps of the recording method of this embodiment will now be described.

### 2.1 Ejection Step

The recording method of this embodiment includes an ejection step of ejecting the above-described ink jet ink composition by an ink jet method so as to apply the above-described ink jet ink composition to an intermediate transfer medium.

The ejection of the ink composition by an ink jet method can be performed using a droplet ejection apparatus (e.g., an ink jet recording apparatus). A piezo method, a method in which the ink composition is ejected by bubbles generated by heating the ink composition, or the like can be used as the droplet ejection method. A piezo method is preferred from the viewpoint of the ink composition being unlikely to be deteriorated.

Paper such as plain paper, a recording medium provided with an ink receiving layer (called ink jet paper, coated paper, etc.), etc. can be used as the intermediate transfer medium. Among them, paper provided with an ink receiving layer containing inorganic particles such as silica is preferred. The use of such paper can obtain an intermediate recorded product in which bleeding of the ink composition on the recording surface of the medium has been reduced in the process of drying of the ink composition applied to the intermediate transfer medium. Further, the colorant can be easily retained on the recording surface of such a medium. This enables more efficient sublimation of the colorant in the later transfer step.

### 2.2 Transfer Step

The recording method of this embodiment includes a transfer step of transferring the ink jet ink composition applied to the intermediate transfer medium to a recording medium. A printed product using a fabric or the like as a recording medium is obtained by this step.

The transfer step is preferably performed by heating the recording surface of the intermediate transfer medium, to which the ink jet ink composition has been applied, while keeping the recording surface facing the recording medium, thereby subliming and transferring the colorant in the ink jet ink composition onto the recording medium. More preferably, the recording surface of the intermediate transfer medium is heated while keeping the intermediate transfer medium in contact with the recording medium. This makes it possible to record images having superior color saturation on the recording medium.

There is no particular limitation on the heating temperature in the transfer step; it may be not less than 160° C. and not more than 220° C., preferably not less than 170° C. and not more than 200° C. Such a heating temperature is likely to be capable of providing the ink composition with a sufficient energy to transfer the colorant to the recording medium, thus achieving excellent productivity of a printed product.

Though the heating time in the transfer step depends on the heating temperature, it is preferably not less than 30 seconds and not more than 90 seconds, more preferably not less than 40 seconds and not more than 60 seconds. Such a heating time is likely to be capable of providing the ink composition with a sufficient energy to transfer the colorant to the recording medium, thus achieving particularly excellent productivity of a printed product.

The shape of the recording medium is preferably a sheet-like shape such as a fabric (e.g., hydrophobic-fiber fabric) or a resin (plastic) film. However, a three-dimensional shape, such as a spherical shape or a rectangular parallelepiped shape, may also be used.

The recording medium may be made of, for example, resin, plastic, glass, metal or ceramic. Examples of fibers, constituting a fabric as the recording medium, include polyester fibers, nylon fibers, triacetate fibers, diacetate fibers, polyamide fibers, and a blend of two or more types of these fibers. It is also possible to use a blend of at least one type of these fibers and regenerated fibers such as rayon fibers, or natural fibers such as cotton, silk or wool fibers.

Examples of a resin (plastic) film as the recording medium include a polyester film, a polyurethane film, a polycarbonate film, a polyphenylene sulfide film, a polyimide film, and a polyamide-imide film. The resin (plastic) film may be a laminate composed of a plurality of laminated layers, or may be made of a gradient material whose composition varies in a gradient manner.

### 2.3 Other Steps

The recording method of this embodiment may further include a first heating step of heating the intermediate transfer medium after the ejection step. The first heating step is a step of heating the intermediate transfer medium after ejecting the ink jet ink composition onto the intermediate transfer medium. The first heating step promotes drying of the ink jet ink composition applied to the intermediate transfer medium in the ejection step. This may inhibit bleeding of images and inhibit set-off.

The temperature to be reached by the intermediate transfer medium in the first heating step is preferably 60° C. or more, more preferably not less than 70° C. and not more than 120° C., and even more preferably not less than 70° C. and not more than 110° C. When the temperature is within the above ranges, the colorant is unlikely to sublime and a good drying rate can be achieved.

The recording method of this embodiment may also include a second heating step of heating at least one of an ink jet head and the intermediate transfer medium in the ejection step. Further, the recording method of this embodiment may include a step of placing the recording medium on the recording surface of the intermediate transfer medium, and a step of heating the intermediate transfer medium and the recording medium.

### 2.4 Recording Apparatus for Use in Recording Method

In the recording method of this embodiment, the ejection of the ink composition by an ink jet method is preferably performed using an ink jet recording apparatus. There is no particular limitation on the ink jet recording apparatus as long as it can eject the ink jet ink composition from an ink jet head and can form images on the intermediate transfer medium. The ink jet recording apparatus preferably includes at least an ink container (cartridge, tank, or the like) for storing an ink, and an ink jet head coupled thereto.

The ink jet recording apparatus may be of either a serial type or a line type. Such a type of ink jet recording apparatus is equipped with an ink jet head, and is configured to eject ink droplets at predetermined volumes from the nozzle holes of the ink jet head with predetermined timings so as to apply the ink droplets to the intermediate transfer medium while changing the relative positional relationship between the intermediate transfer medium and the ink jet head, so that predetermined images can be formed on the intermediate transfer medium.

In general, in a serial-type ink jet recording apparatus, the traveling direction of the intermediate transfer medium intersects the direction of reciprocating movement of the ink jet head. The relative positional relationship between the intermediate transfer medium and the ink jet head is changed by combining the reciprocating movement of the ink jet head and the traveling movement of the intermediate transfer medium. The ink jet head generally has a plurality of nozzle holes; a row of nozzle holes are formed along the traveling direction of the intermediate transfer medium. In some cases, a plurality of nozzle rows are formed in the ink jet head depending on the types and number of ink compositions.

In general, in a line-type ink jet recording apparatus, the ink jet head makes no reciprocating movement. The relative positional relationship between the intermediate transfer medium and the ink jet head is changed by traveling of the intermediate transfer medium. Also in such a recording apparatus, the ink jet head generally has a plurality of nozzle holes; a row of the nozzle holes are formed along a direction intersecting the traveling direction of the intermediate transfer medium.

The ink jet recording method uses a serial-type or line-type ink jet recording apparatus. There is no particular limitation on the method as long as it can eject the ink as droplets from small nozzle holes so as to apply the droplets to the intermediate transfer medium. For example, a piezo method or a method in which the ink is ejected by bubbles generated by heating the ink can be used as a droplet ejection method. A piezo method is preferred from the viewpoint of the ink being unlikely to be deteriorated by heat.

The ink jet recording apparatus may be provided with any known component or equipment such as a heating unit, a drying unit, a roll unit, a winding unit, etc.

### 3. EXAMPLES

The following examples illustrate the present disclosure in greater detail and are not intended to limit the scope of the disclosure. In the following description, “%” is based on mass unless otherwise specified.

### 3.1 Preparation of Ink Jet Ink Composition

### Preparation of Colorant Dispersion

The colorants A to I listed in Table 1 below were prepared in the following manner.

Colorants A, G, H, and I were provided which had been purified by an appropriate known method. In high-performance liquid chromatography (HPLC) analysis of each of the colorants performed under the below-described conditions, the peak area of the compound (A) represented by formula (1) below, the peak area of the compound (B) represented by formula (2) below and the peak area of the compound (C) represented by formula (3) below were as described in Table 1 below based on 100% of the total peak area of the colorant.

Colorants B to F were each prepared appropriately by mixing the colorants A and G at such a mixing ratio as to make the peak areas of the compounds (A) to (C) in HPLC analysis of the resulting colorant as described in Table 1 below.

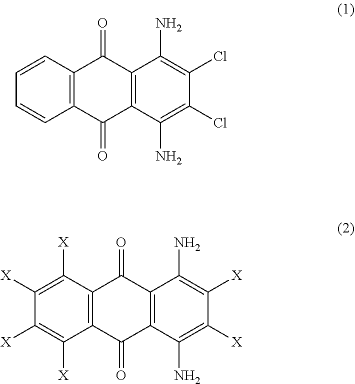

where X represents a hydrogen atom or a chlorine atom, X's may be the same or different, and formula (2) excludes the structure of formula (1),

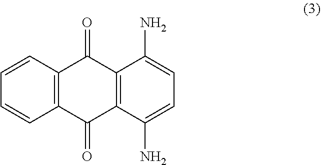

### HPLC Measurement Conditions

Apparatus used: SPD-M20A (manufactured by Shimadzu

Corporation)
Column: Inertsil ODS-2 (4.6 mm×250 mm) (particle size 5 μm) Column temperature: 40° C.
Eluent: acetonitrile/5 mM ammonium acetate=70/30
Flow rate: 0.8 mL/min
Sample injection volume: 2 μL
Detection wavelength: 500 nm

TABLE 1

| | Colorant A | Colorant B | Colorant C | Colorant D | Colorant E | Colorant F | Colorant G | Colorant H | Colorant I |
|---|---|---|---|---|---|---|---|---|---|
| Compound | 0.6% | 1.0% | 1.2% | 1.5% | 1.7% | 1.8% | 2.3% | 1.0% | 6.1% |
| (B) | | | | | | | | | |
| Compound | 0.0% | 0.2% | 0.4% | 0.6% | 0.8% | 0.9% | 1.2% | 1.0% | 3.1% |
| (C) | | | | | | | | | |
| Compound | Remainder | Remainder | Remainder | Remainder | Remainder | Remainder | Remainder | Remainder | Remainder |
| (A) | | | | | | | | | |
| Total | 100% | 100% | 100% | 100% | 100% | 100% | 100% | 100% | 100% |

15.0 parts by mass of each of the colorants listed in Table 1 above, 15.0 parts by mass of a Na salt of a formalin condensate of naphthalenesulfonic acid, and pure water in such an amount as to make the total mass of the resulting dispersion 100 parts by mass were added to a container and mixed. Thereafter, the mixture was dispersed in a paint shaker using 0.3-mm zirconia beads to obtain each of colorant dispersions A to I.

Components listed in Tables 2 and 3 below were placed in a container in amounts corresponding to each of the compositions shown in the Tables, and mixed and stirred with a magnetic stirrer for 2 hours, and then the mixture was filtered through a membrane filter having a pore size of 1 μm to obtain an ink jet ink composition of each of Examples and Comparative Examples. Pure water was added in such an amount as to make the total mass of the composition 100 parts by mass.

TABLE 2

| Materials | | | | Comp. | Comp. | Comp. | Comp. | Comp. | Comp. |
|---|---|---|---|---|---|---|---|---|---|
| used | Example 1 | Example 2 | Example 3 | Example 1 | Example 2 | Example 3 | Example 4 | Example 5 | Example 6 |
| Colorant | 25 | | | | | | | | |
| dispersion | | | | | | | | | |
| A | | | | | | | | | |
| Colorant | | 25 | | | | | | | |
| dispersion | | | | | | | | | |
| B | | | | | | | | | |
| Colorant | | | 25 | | | | | | |
| dispersion | | | | | | | | | |
| C | | | | | | | | | |
| Colorant | | | | 25 | | | | | |
| dispersion | | | | | | | | | |
| D | | | | | | | | | |
| Colorant | | | | | 25 | | | | |
| dispersion | | | | | | | | | |
| E | | | | | | | | | |
| Colorant | | | | | | 25 | | | |
| dispersion | | | | | | | | | |
| F | | | | | | | | | |
| Colorant | | | | | | | 25 | | |
| dispersion | | | | | | | | | |
| G | | | | | | | | | |
| Colorant | | | | | | | | 25 | |
| dispersion | | | | | | | | | |
| H | | | | | | | | | |
| Colorant | | | | | | | | | 25 |
| dispersion | | | | | | | | | |
| I | | | | | | | | | |
| Glycerin | 15 | 15 | 15 | 15 | 15 | 15 | 15 | 15 | 15 |
| Propylene | 10 | 10 | 10 | 10 | 10 | 10 | 10 | 10 | 10 |
| glycol | | | | | | | | | |
| BYK348 | 0.5 | 0.5 | 0.5 | 0.5 | 0.5 | 0.5 | 0.5 | 0.5 | 0.5 |
| Pure water | Remainder | Remainder | Remainder | Remainder | Remainder | Remainder | Remainder | Remainder | Remainder |
| Total | 100 | 100 | 100 | 100 | 100 | 100 | 100 | 100 | 100 |
| Color | A | B | B | C | C | C | C | B | D |
| saturation | | | | | | | | | |
| evaluation | | | | | | | | | |
| results | | | | | | | | | |
| Storage | A | A | A | A | B | C | C | C | C |
| stability | | | | | | | | | |
| evaluation | | | | | | | | | |
| results | | | | | | | | | |

TABLE 3

| | | | | | | | | | | | | Comp | Comp |
|---|---|---|---|---|---|---|---|---|---|---|---|---|---|
| | | Exam- | Exam- | Exam- | Exam- | Exam- | Exam- | Exam- | Exam- | Exam- | Exam- | Exam- | Exam- |
| Materials used | | ple 1 | ple 4 | ple 5 | ple 6 | ple 7 | ple 8 | ple 9 | ple 10 | ple 11 | ple 12 | ple 7 | ple 8 |
| Colorant | | 25 | 25 | 25 | 25 | 25 | 25 | | | | | | |
| dispersion | | | | | | | | | | | | | |
| A | | | | | | | | | | | | | |
| Colorant | | | | | | | | 25 | 25 | 25 | 25 | | |
| dispersion | | | | | | | | | | | | | |
| C | | | | | | | | | | | | | |
| Colorant | | | | | | | | | | | | 25 | 25 |
| dispersion | | | | | | | | | | | | | |
| I | | | | | | | | | | | | | |
| Water- | Glycerin | 15 | 20 | 22 | 20 | 22 | 14 | 15 | 20 | 22 | 20 | 15 | 14 |
| soluble | Propylene | 10 | 5 | 6 | 3 | | 1 | 10 | 5 | 6 | 3 | 10 | 1 |
| organic | glycol | | | | | | | | | | | | |
| solvent | Diethylene | | | | | 18 | | | | | | | |
| | glycol | | | | | | | | | | | | |
| | TEGMME | | | 3 | | | | | | 3 | | | |
| | TEGMEE | | | | 2 | | | | | | 2 | | |
| BYK348 | | 0.5 | 0.5 | 0.5 | 0.5 | 0.5 | 0.5 | 0.5 | 0.5 | 0.5 | 0.5 | 0.5 | 0.5 |
| Pure water | | Re- | Re- | Re- | Re- | Re- | Re- | Re- | Re- | Re- | Re- | Re- | Re- |
| | | main- | main- | main- | main- | main- | main- | main- | main- | main- | main- | main- | main- |
| | | der | der | der | der | der | der | der | der | der | der | der | der |
| Total | | 100 | 100 | 100 | 100 | 100 | 100 | 100 | 100 | 100 | 100 | 100 | 100 |
| Total amount of | | 25 | 25 | 31 | 25 | 40 | 15 | 25 | 25 | 31 | 25 | 25 | 15 |
| water-soluble | | | | | | | | | | | | | |
| organic solvent | | | | | | | | | | | | | |
| Ejection stability | | A | A | A | A | B | B | B | B | B | B | C | D |
| evaluation results | | | | | | | | | | | | | |

The following is a supplemental description of some components shown in Tables 2 and 3 above.
BYK348 [trade name, silicone surfactant, available from BYK Japan KK]
TEGMME [triethylene glycol monomethyl ether]
TEGMEE [triethylene glycol monoethyl ether]

### 3.2 Evaluation Method

### 3.2.1 Color Saturation

Recording with each of the ink jet ink compositions obtained was performed on the surface of a coating layer of coated paper (TRANSJET Sportline 1254 (trade name), manufactured by Cham Paper Group Holding AG) as an intermediate transfer medium at a resolution of 720×720 dpi using an ink jet printer (trade name PX-G930, manufactured by Seiko Epson Corporation), outputting a fill pattern of ink at a duty of 10% to 100%. Thereafter, the ink-applied side of the intermediate transfer medium was brought into contact with a fabric (100% polyester, CARL DRY, manufactured by Toray Industries, Inc.) as a white recording medium, and the laminate was heated under the conditions of 200° C. and 40 seconds using a heat press machine (AF-54TEN, manufactured by Itsumi) to perform sublimation transfer, thereby obtaining a dyed product as a test sample. The sample was subjected to measurement under the conditions of light: D₆₅ light source, and viewing angle: 2 degrees using a spectrophotometric colorimeter (trade name “FD-7”, manufactured by Konica Minolta, Inc.), and an a* value and a b* value were calculated. A color saturation C* (√(a*²+b*²)) was calculated from the a* value and the b* value obtained, and was evaluated according to the following criteria.

### Evaluation Criteria

A: the maximum color saturation of the image obtained was 77 or more
B: the maximum color saturation of the image obtained was not less than 75 and less than 77
C: the maximum color saturation of the image obtained was not less than 73 and less than 75
D: the maximum color saturation of the image obtained was less than 73

### 3.2.2 Storage Stability

100 g of each of the ink jet ink compositions was placed in a glass bottle. The bottle was closed by a cap, and stored in a 60° C. environment for two weeks. Thereafter, the ink composition was filtered through a metal mesh filter having a pore size of 10 μm, and the number of solids per mm² remaining on the metal mesh filter was counted and evaluated according to the following criteria.

### Evaluation Criteria

A: the number of solids per mm² was Less than 5
B: the number of solids per mm² was not less than 5 and less than 30
C: the number of solids per mm² was 30 or more

### 3.2.3 Ejection Stability

Each of the ink jet ink compositions was charged into an ink jet printer (trade name PX-G930, manufactured by Seiko Epson Corporation), and allowed to stand for 20 minutes with the head cap of an ink cartridge open. Thereafter, cleaning was performed once, and 20 solid patterns were printed, and then a nozzle check pattern was printed to check the nozzles for ejection failure and misdirected ejection. The ejection stability of the ink composition was evaluated according to the following criteria. The test environment was set at a temperature of 40° C. and a humidity of 20%.

### Evaluation Criteria

A: ejection failure or misdirected ejection occurred in 0 nozzle out of 180 nozzles
B: ejection failure or misdirected ejection occurred in 1 to 10 nozzles out of 180 nozzles
C: ejection failure or misdirected ejection occurred in 11 to 90 nozzles out of 180 nozzles
D: ejection failure or misdirected ejection occurred in 91 to 180 nozzles out of 180 nozzles

### 3.3 Evaluation Results

The evaluation results are shown in Tables 2 and 3 above.

The evaluation results indicate that excellent color saturation of a dyed product and excellent storage stability of the ink can be achieved by the ink compositions of the Examples which each include: a colorant including a compound (A) represented by the above formula (1); an anionic dispersant; water; a surfactant; and a water-soluble organic solvent, in which in high-performance liquid chromatography (HPLC) analysis of the colorant at a measurement wavelength of 500 nm, the peak area of a compound (B) represented by the above formula (2) is 1.4% or less based on 100% of the total peak area of the colorant, and the peak area of a compound (C) represented by the above formula (3) is 0.8% or less based on 100% of the total peak area of the colorant, and in which the water-soluble organic solvent includes a glycerol and a glycol.

In contrast, excellent color saturation of a dyed product and excellent storage stability of the ink cannot be achieved by the ink compositions of the Comparative Examples in which the peak area of the compound (B) and/or the peak area of the compound (C) are/is more than the particular value (s) based on 100% of the total peak area of the colorant.

The following can be derived from the embodiments described above.

According to one aspect, an ink jet ink composition includes: a colorant including a compound (A) represented by formula (1) below; an anionic dispersant; water; a surfactant; and a water-soluble organic solvent, in which in high-performance liquid chromatography analysis or HPLC analysis of the colorant at a measurement wavelength of 500 nm, a peak area of a compound (B) represented by formula (2) below is 1.4% or less based on 100% of a total peak area of the colorant, and a peak area of a compound (C) represented by formula (3) below is 0.8% or less based on 100% of the total peak area of the colorant, and in which the water-soluble organic solvent includes a glycerol and a glycol:

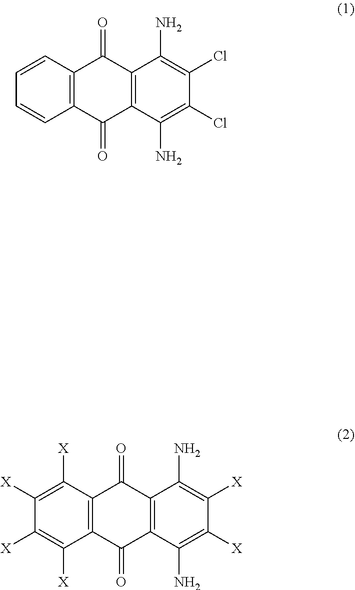

where X represents a hydrogen atom or a chlorine atom, X's are same or different, and the formula (2) excludes a structure of the formula (1),

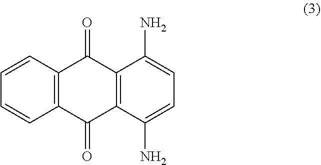

In the ink jet ink composition according to the above aspect, a content ratio between the glycerol and the glycol or glycerol:glycol may be 3:2 to 20:3 based on mass.

In the ink jet ink composition according to any one of the above aspects, the water-soluble organic solvent may further include a glycol ether, and a content of the glycol ether may be not less than 1% by mass and not more than 3% by mass based on a total mass of the ink composition.

In the ink jet ink composition according to any one of the above aspects, the water-soluble organic solvent may further include a glycol ether, and a content of the water-soluble organic solvent may be not less than 15% by mass and not more than 40% by mass based on a total mass of the ink composition.

In the ink jet ink composition according to any one of the above aspects, the anionic dispersant may be a formalin condensate of sodium naphthalenesulfonate.

In the ink jet ink composition according to any one of the above aspects, the surfactant may be a silicone surfactant.

In the ink jet ink composition according to any one of the above aspects, in high-performance liquid chromatography analysis or HPLC analysis of the colorant at a measurement wavelength of 500 nm, a peak area of the compound (A) represented by the formula (1) may be 98.6% or more based on 100% of the total peak area of the colorant.

According to another aspect, a recording method includes an ejection step of ejecting the above-described ink jet ink composition by an ink jet method so as to apply the above-described ink jet ink composition to an intermediate transfer medium; and a transfer step of transferring the ink jet ink composition applied to the intermediate transfer medium to a recording medium.

The present disclosure is not limited to the embodiments described above; various changes and modifications may be made to the embodiments. For example, the present disclosure includes features which are substantially the same, e.g. in terms of function, method and results or in terms of purpose and effect, as features described above with reference to the embodiments. Further, the present disclosure includes features which are the same as those described above with reference to the embodiments except that non-essential matter is replaced. Further, the present disclosure includes features which achieve the same effect or can achieve the same object as features described above with reference to the embodiments. In addition, the present disclosure includes features which add a known technique to features described above with reference to the embodiments.

What is claimed is:

1. An ink jet ink composition comprising: a colorant including a compound (A) represented by formula (1) below; an anionic dispersant; water; a surfactant; and a water-soluble organic solvent, wherein
in high-performance liquid chromatography analysis or HPLC analysis of the colorant at a measurement wavelength of 500 nm,
a peak area of a compound (B) represented by formula (2) below is 1.4% or less based on 100% of a total peak area of the colorant, and
a peak area of a compound (C) represented by formula (3) below is 0.8% or less based on 100% of the total peak area of the colorant, and wherein
the water-soluble organic solvent includes a glycerol and a glycol: 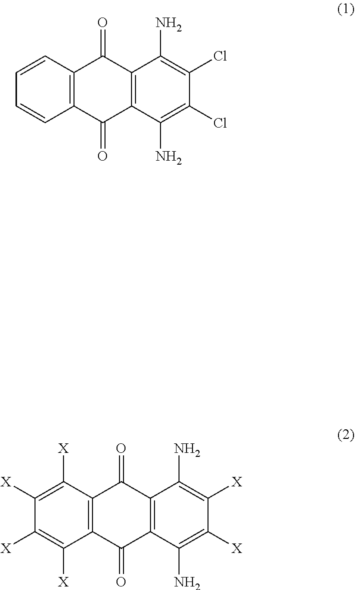
where X represents a hydrogen atom or a chlorine atom, X's are same or different, and the formula (2) excludes a structure of the formula (1),

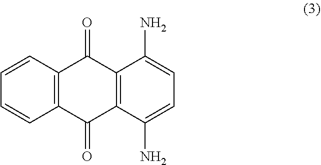

2. The ink jet ink composition according to claim 1, wherein
a content ratio between the glycerol and the glycol or glycerol: glycol is 3:2 to 20:3 based on mass.

3. The ink jet ink composition according to claim 1, wherein
the water-soluble organic solvent further includes a glycol ether, and a content of the glycol ether is not less than 1% by mass and not more than 38 by mass based on a total mass of the ink composition.

4. The ink jet ink composition according to claim 1, wherein
the water-soluble organic solvent further includes a glycol ether, and a content of the water-soluble organic solvent is not less than 15% by mass and not more than 40% by mass based on a total mass of the ink composition.

5. The ink jet ink composition according to claim 1, wherein
the anionic dispersant is a formalin condensate of sodium naphthalenesulfonate.

6. The ink jet ink composition according to claim 1, wherein
the surfactant is a silicone surfactant.

7. The ink jet ink composition according to claim 1, wherein
in high-performance liquid chromatography analysis or HPLC analysis of the colorant at a measurement wavelength of 500 nm,
a peak area of the compound (A) represented by the formula (1) is 98.6% or more based on 100% of the total peak area of the colorant.

8. A recording method comprising:
an ejection step of ejecting the ink jet ink composition according to claim 1 by an ink jet method so as to apply the ink jet ink composition to an intermediate transfer medium; and
a transfer step of transferring the ink jet ink composition applied to the intermediate transfer medium to a recording medium.
